(19) United States
(12) Patent Application Publication
(10) Pub. No.: US 2023/0242844 A1
(43) Pub. Date: Aug. 3, 2023

(54) PERFUME-CONTAINING PARTICLES AND THE MAKING METHOD

(71) Applicant: The Procter & Gamble Company, Cincinnati, OH (US)

(72) Inventors: Rui SHEN, Beijing (CN); Pu ZHAO, Beijing (CN)

(21) Appl. No.: 18/103,064

(22) Filed: Jan. 30, 2023

(30) Foreign Application Priority Data
Jan. 30, 2022 (WO) PCT/CN2022/075156

(51) Int. Cl. C11D 3/50; C11B 9/00; C11D 17/00

(52) U.S. Cl. CPC C11D 3/505; C11B 9/0073; C11D 17/0039

(57) ABSTRACT

A method of making perfume-containing particles. Each of such particles contains a perfume ingredient; a first carrier, and a second carrier. The first carrier includes water-soluble and hot-meltable material. The second carrier includes water-soluble or water-dispersible particle. From 80 wt % to 100 wt % of the second carrier are characterized by a particle size ranging from 5 microns to 150 microns. Each of the perfume-containing particles has a mass of from 0.1 mg to 5 g and a maximum dimension of from 3 mm to 10 mm. The method includes steps of: a) providing an intermediate particle, wherein the intermediate particle includes at least the second carrier, and a binder, b) mixing the intermediate particle, the perfume ingredient, the first carrier in a molten state, and optionally one or more other ingredients, to form a slurry, and c) forming the perfume-containing particles from the slurry.

### FIELD OF THE INVENTION

This invention is related to perfume-containing particles and the method of making the same.

### BACKGROUND OF THE INVENTION

Scent is recognized to be a source of pleasure to consumers when they do their laundry. Consumers may associate certain scents with performance of the laundry products and as an indicator of quality of the laundry products. Laundry products that provide a pleasant or enhanced scent experience to the consumer when she dispenses the laundry product, transfers a load of wet laundry from the washer to the dryer or to a drying rack or line, or when she wears the clothing meet this consumer need.

Correspondingly, perfumed particles are becoming increasingly popular as a laundry scent additive. The perfumed particles can be used to impart new scent to, or enhance existing scent in, the articles being washed.

Most of such perfumed particles contains one or more perfume ingredients mixed carrier materials. The perfume ingredients may be selected from the group consisting of free perfumes, encapsulated perfumes, and combinations thereof. The carrier materials may be selected from the group consisting of: polymers (e.g., polyethylene glycol, ethylene oxide/propylene oxide block copolymers, polyvinyl alcohol, polyvinyl acetate, and derivatives thereof), proteins (e.g., gelatin, albumin, casein, and the like), sugars (e.g., dextrose, fructose, galactose, glucose, isoglucose, sucrose, and the like), polysaccharides (e.g., starch, cellulose, or derivatives thereof), water-soluble or water-dispersible fillers (e.g., sodium chloride, sodium sulfate, sodium carbonate/bicarbonate, zeolite, silica, clay, and the like), and combinations thereof. Some perfumed particles contain only one type of carrier material, while others may contain a mixture of two or more different carrier materials.

US20190218480A discloses perfumed particles containing mixture of polymer (e.g., polyethylene glycol) with a water-soluble or water-dispersible filler with specific range of particle size, which obtains significantly reduced compositional variations, thus providing better product quality control, consistent user experience and consumer satisfaction. However, there are challenges during manufacturing for handling fine powder of filler particles. First of all, it needs very careful operating procedures to handle fine powder of filler particles due to the dustiness. Secondly, some of fine powder of filler particle is easy to absorb moisture to clogging thus needs extra deliberate conditions for storage and transporting. In cases that discrete particles with specific particle sizes are needed, it may need extra capital investment thus resulting processing complexity.

There is therefore a need to provide improved process for making perfumed particles containing filler carrier having small particle sizes, with better operating feasibility. There is further desire to provide filler carrier particles not easy to be agglomerated even under moisture or long transportation, so as to reduce capital investment, save operational cost and/or simplify processing complexity.

### SUMMARY OF THE INVENTION

The applicants surprisingly discover an improved method for making perfume-containing particles wherein a water-soluble or water-dispersible carrier (a filler) can distribute in the particles with a specific range of particle size by an easier operating way. Such method introduces a pre-formed intermediate particle made by granulation of the water-soluble or water-dispersible carrier with a hot-meltable binder. Granulation leads to more homogenous particles with better flow characteristics. Granules is easy to be stored and shipped compared with powder. The granulation process can modify or improve the filler release profile during the subsequent process of making perfume-containing particles. Surprisingly, the filler released from the intermediate particle re-melts into the perfume-containing particle by remaining the specific range of particle size.

In one aspect, the present invention is related to a method of making perfume-containing particles, wherein the perfume-containing particles comprise: a perfume ingredient; a first carrier, and a second carrier, wherein the first carrier comprises water-soluble and hot-meltable material, and the second carrier comprises water-soluble or water-dispersible particle, wherein from 80 wt % to 100 wt % of the second carrier are characterized by a particle size ranging from 5 microns to 150 microns, wherein each of said perfume-containing particles has a mass of from 0.1 mg to 5 g and a maximum dimension of from 3 mm to 10 mm, said method comprising steps of:

a) providing an intermediate particle characterized by a maximum dimension ranging from 0.5 mm to 10 mm, wherein the intermediate particle comprises at least the second carrier, and a binder,

b) mixing the intermediate particle, the perfume ingredient, the first carrier in a molten state, and optionally one or more other ingredients, to form a slurry, and

c) forming the perfume-containing particles from the slurry.

Preferably, the intermediate particle is provided by granulation of the second carrier and the binder. The intermediate particle can be provided by, for example, high-shear wet granulation, low-shear wet granulation, fluid bed wet granulation, dry granulation, spray drying granulation, rotor granulation, extrusion, hot-melt granulation, and so on. The intermediate particle can be of any suitable shape. For example, the intermediate particle can be of any regular shape, such as cube, sphere, semi-sphere, cylindrical, noodle, or it can be irregular shape. Preferably, the intermediate particle is characterized by a maximum dimension ranging from 0.5 mm to 10 mm, preferably from 0.6 mm to 9 mm, more preferably from 0.8 mm to 8 mm.

The first carrier in the perfume-containing particles may comprise water-soluble and hot-meltable material, preferably having melting point from 35° C. to 70° C. The first carrier can be materials selected from polyethylene glycol, polypropethylene glycol, ethylene oxide/propylene oxide block copolymers, nonionic surfactant, and combinations thereof. For example, the first carrier can be polyethylene glycol having a weight average molecular weight (Mw) from 2,000 to 30,000 Daltons, preferably from 3,000 to 20,000 Daltons, more preferably from 4,000 to 15,000 Daltons. Preferably, the first carrier may be present in each of said perfume-containing particle in an amount ranging from 5% to 90%, preferably from 10% to 70%, more preferably from 20% to 60%, by total weight of each perfume-containing particles.

The second carrier in the perfume-containing particle may comprise a material selected from the group consisting of sodium chloride, sodium sulfate, sodium carbonate, sodium bicarbonate, sodium citrate, magnesium chloride, magnesium sulfate, potassium chloride, potassium sulfate, potassium carbonate, potassium bicarbonate, calcium bicarbonate, zeolite, silica, clay, and combinations thereof, preferably selected from sodium chloride, sodium sulfate, sodium carbonate, or combinations thereof. Preferably, from 80 wt % to 100 wt % of said second carrier present in the perfume-containing particles are characterized by a particle size ranging from 10 microns to 125 microns, preferably from 10 microns to 105 microns, more preferably from 10 microns to 90 microns. Preferably, the second carrier may be present in each perfume-containing particle in an amount ranging from about 1% to about 90%, preferably from about 5% to about 50%, more preferably from about 8% to about 40%, by total weight of each perfume-containing particle.

Preferably, the binder in the intermediate particle comprises materials selected from polyethylene glycol, ethylene oxide/propylene oxide block copolymers, polyvinyl alcohol, polyvinyl acetate, and derivatives thereof; gelatin, albumin, casein, dextrose, fructose, galactose, glucose, isoglucose, sucrose; polysaccharides, cellulose, starch, or derivatives thereof; nonionic surfactant, anionic surfactant, cationic surfactant, and combinations thereof.

In some preferred examples, the weight ratio of the second carrier to the binder in the intermediate particle is about 50-99: 1-50. For example, the weight ratio of the second carrier to the binder in the intermediate particle can be 50:50, or 55:45, or 60:40, or 65:35, or 70:30, or 75:25, or 80:20, or 85:15, or 90:10, or 95:5, and any combination between the above-mentioned ranges.

Each of the above-mentioned perfume-containing particles may comprise one or more perfume ingredients selected from the group consisting of free perfumes, encapsulated perfumes, and combinations thereof. In a specific embodiment, the perfume-containing particles contain one or more free perfumes, which are preferably present in an amount ranging from about 0.1% to about 25%, alternatively from about 0.2% to about 20%, preferably from about 0.5% to about 15%, more preferably from about 1% to about 10%, by total weight of each perfume-containing particle. Further, the perfume-containing particles may contain, either alone or in combination with the free perfumes, an encapsulated perfume. Preferably, the encapsulated perfume is present in friable perfume microcapsules, while the friable perfume microcapsules are preferably present in an amount ranging from about 0.1% to about 25%, alternatively from about 0.2% to about 20%, preferably from about 0.5% to about 10%, more preferably from about 1% to about 5%, by total weight of each perfume-containing particle.

Optionally, the perfume-containing particles of the present invention may further comprise one or more other ingredients selected from the group consisting of colorants, solvents, softening actives, and combinations thereof. In some examples, said one or more ingredients are present in an amount ranging from 0.01% to 10%, preferably from 0.02% to 8%, more preferably from 0.1% to 5%, by total weight of each perfume-containing particle.

These and other aspects of the present invention will become more apparent upon reading the following detailed description of the invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “perfume-containing particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “aspect ratio” refers to the ratio of the longest dimension of the perfume-containing particles over its shortest dimension. For example, when such perfume-containing particles have a hemispherical or compressed hemispherical shape, the aspect ratio is the ratio between the based diameter of the perfume-containing particles over its height.

The term “consisting essentially of” means that the composition contains less than about 1%, preferably less than about 0.5%, of ingredients other than those listed.

Further, the term “substantially free of” or “substantially free from” means that the indicated material is present in the amount of from 0 wt % to about 1 wt %, preferably from 0 wt % to about 0.5 wt %, more preferably from 0 wt % to about 0.2 wt %. The term “essentially free of” means that the indicated material is present in the amount of from 0 wt % to about 0.1 wt %, preferably from 0 wt % to about 0.01 wt %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

### Method of Making Perfume-Containing Particles

The present invention is related to perfume-containing particles and the method of making the same. The perfume-containing particles comprise: a perfume ingredient; a first carrier, and a second carrier, wherein the first carrier comprises water-soluble and hot-meltable material, and the second carrier comprises water-soluble or water-dispersible particle. The method of making the perfume-containing particles comprises steps of: a) providing an intermediate particle characterized by a maximum dimension ranging from 0.5 mm to 10 mm, wherein the intermediate particle comprises at least the second carrier, and a binder, b) mixing the intermediate particle, the perfume ingredient, the first carrier in a molten state, to form a slurry, and c) forming the perfume-containing particles from the slurry.

The introduction of the step of providing an intermediate particle comprising at least the second carrier and a binder, brings out homogeneous perfume-containing particles, wherein the second carrier retains its specific particle size characterization through the manufacturing process. In particularly, in the perfume-containing particles, from 80 wt % to 100 wt % of the second carrier are characterized by a particle size ranging from 5 microns to 150 microns, wherein each of said perfume-containing particles contains from about 1% to about 90%, preferably from about 5% to about 50%, more preferably from about 8% to about 40%, by weight, of the second carrier. The second carrier comprises water-soluble or water-dispersible particle, which is selected from the group consisting of sodium chloride, sodium sulfate, sodium carbonate, sodium bicarbonate, sodium citrate, magnesium chloride, magnesium sulfate, potassium chloride, potassium sulfate, potassium carbonate, potassium bicarbonate, calcium bicarbonate, zeolite, silica, clay, and combinations thereof, preferably selected from sodium chloride, sodium sulfate, sodium carbonate, or combinations thereof.

The intermediate particle is provided by granulation of the second carrier and the binder. The intermediate particle can be provided by, for example, high-shear wet granulation, low-shear wet granulation, fluid bed wet granulation, dry granulation, spray drying granulation, rotor granulation, extrusion, hot-melt granulation, and so on. The intermediate particle can be of any suitable shape. For example, the intermediate particle can be of any regular shape, such as cube, sphere, semi-sphere, cylindrical, noodle, or it can be irregular shape. Preferably, the intermediate particle is characterized by a maximum dimension ranging from 0.5 mm to 10 mm, preferably from 0.6 mm to 9 mm, more preferably from 0.8 mm to 8 mm. Preferably, the intermediate particle may have an aspect ratio (longest dimension vs. shortest dimension) of from about 20:1 to about 1:1, or from about 15:1 to about 1:1, or from about 10:1 to about 1:1. For example, the intermediate particle may have a noodle or cylindrical shape having the aspect ratio from about 20:1 to about 3:1, or have a maximum dimension, and a semi-sphere shape having the aspect ratio from about 1.5:1 to about 1:1.

The binder used in the intermediate particle may comprise materials selected from polyethylene glycol, ethylene oxide/propylene oxide block copolymers, polyvinyl alcohol, polyvinyl acetate, and derivatives thereof; gelatin, albumin, casein, dextrose, fructose, galactose, glucose, isoglucose, sucrose; polysaccharides, cellulose, starch, or derivatives thereof; nonionic surfactant, anionic surfactant, cationic surfactant, and combinations thereof. Preferably, the binder in the intermediate particle can be compatible with the first carrier. Particularly, the binder can comprise the same material as the first carrier. Alternatively, the binder can comprise different material from the first carrier, but the binder material can be at least compatible with the material of the first carrier.

The intermediate particle may optionally contain any other suitable or compatible ingredients, described in the part of Optional/Adjunct Ingredients hereinafter. In preferred by not necessary examples, the intermediate particle may further contain adjunct ingredients selected from pH modifiers, colorants, solvents, softening actives, germ killing materials, anti-mite materials, dye transfer inhibitors, silicon, polymer, and combinations thereof. For example, the adjunct ingredient in the intermediate particle can be present in the range of from about 0.01% to about 40%, preferably from about 0.1% to about 30%.

The method of making the perfume-containing particles of the present invention may be conducted in either a batch mode or a continuous mode. In either mode, it is first provided the intermediate particle comprising at least the water-soluble or water-dispersible second carrier and the binder using suitable granulation method described hereinabove. The second carrier can be material selected from the list consisting of sodium chloride particles, sodium sulfate particles, sodium carbonate particles, and the like. The binder used in the intermediate particle can be selected from polymers (e.g., polyethylene glycol, ethylene oxide/propylene oxide block copolymers, polyvinyl alcohol, polyvinyl acetate, and derivatives thereof), proteins (e.g., gelatin, albumin, casein, and the like), sugars (e.g., dextrose, fructose, galactose, glucose, isoglucose, sucrose, and the like), polysaccharides (e.g., starch, cellulose, or derivatives thereof). In a batch mode, the first carrier (such as molten PEG) is loaded into a mixing vessel having temperature control. Perfume ingredients (e.g., free perfumes and/or PMCs), the intermediate particle, and the optional ingredients (such as dyes, pigments, solvents, and the like) are then added and mixed with the molten PEG until homogeneous. In a continuous mode, molten PEG is mixed with the above-described perfume ingredients, intermediate particles, and optional ingredients in an in-line mixer such as a static mixer or a high shear mixer and the resulting homogeneous mixture is then used for pastillation. Perfume ingredients, intermediate particles and optional ingredients can be added to the molten PEG in any order or simultaneously at a step prior to pastillation.

The perfume-containing particles may be manufactured by a pastillation process. A desired formulation containing the above-described molten PEG, perfume ingredients, intermediate particles, and optional ingredients is provided as a viscous slurry. The viscous slurry can be provided at a processing temperature less than about 20 degrees Celsius above the onset of solidification temperature of the PEG material as determined by differential scanning calorimetry. In one embodiment, the PMCs can be added as a slurry to the molten PEG and free perfume to form the viscous slurry. The PMCs can also be added as a powder to the molten PEG and free perfume to form the viscous slurry.

In a specifically preferred embodiment of the present invention, gas or gas-generating ingredients can be added into the viscous slurry to form an aerated viscous slurry.

The viscous slurry, either aerated or unaerated, can then be formed into perfume-containing particles (especially in form of pastilles) by a ROTOFORMER available from Sandvik Materials Technology. Specifically, the viscous slurry can be distributed through a feed pipe to a stator. A cylinder is provided for rotating about the stator along a longitudinal axis L of such cylinder, wherein the cylinder has a periphery with a plurality of apertures disposed about the periphery. The viscous slurry is then passed through the apertures of the cylinder onto a moving conveyor beneath the cylinder to form droplets of such viscous slurry. Such droplets of the viscous slurry cool down to below the glass transition temperature of the PEG material on the moving conveyor, thereby forming a plurality of pastilles having a hemispherical or compressed hemispherical shape (depending on the viscosity of the slurry). The process can be implemented using any of the apparatuses disclosed herein.

In the present invention, the second carrier (especially inorganic water-soluble particle) was granulated with the binder to form the intermediate particles, before added into the first carrier and perfume ingredients to form the perfume-containing particles. Such step provides the perfume-containing particles containing the second carrier with specific desired particle size distribution as mentioned hereinabove. The intermediate particle can be manufactured well before its usage for making the perfume-containing particles. It can endure long time storage or transportation, being provided into molten first carrier without pretreating in-situ. On the contrary, previous manufacturing method of the perfume-containing particles may involve an extra step of grinding and sieving the second carrier particle, immediately before adding into the molten PEG, which requires more capital investment cost and process complexity.

### Perfume-Containing Particles

The perfume-containing particles made by the method of the present invention may each have a specific shape and size. Each of the perfume-containing particles has a mass of from 0.1 mg to 5 g and a maximum dimension of from 3 mm to 10 mm.

Preferably, the mass of each perfume-containing particle may be from about 1 mg to about 3 g, preferably from about 2 mg to about 2 g, more preferably from about 5 mg to about 1 g, still more preferably from about 10 mg to about 500 mg, still more preferably from about 15 mg to about 300 mg, still more preferably from about 20 mg to about 125 mg, with alternative combinations thereof and any whole numbers or ranges of whole numbers of mg within any of the aforementioned ranges.

The perfume-containing particles of the present invention may have any shape selected from the group consisting of spherical, hemispherical, compressed hemispherical, cylindrical, disc, circular, lentil-shaped, oblong, cubical, rectangular, star-shaped, flower-shaped, and any combinations thereof. Lentil-shaped refers to the shape of a lentil bean. Preferably, the perfume-containing particles of the present invention have a hemispherical or compressed hemispherical shape. Compressed hemispherical refers to a shape corresponding to a hemisphere that is at least partially flattened such that the curvature of the curved surface is less, on average, than the curvature of a hemisphere having the same radius.

The perfume-containing particles of the present invention may each have a maximum dimension of from about 3 mm to 10 mm, preferably from about 4 mm to about 9 mm, more preferably from about 5 mm to about 8 mm A compressed hemispherical particle can have an aspect ratio (i.e., the ratio of its base diameter over its height that is orthogonal to the base) of from about 2.0 to about 5, alternatively from about 2.1 to about 4.5, alternatively from about 2.2 to about 4. Oblong-shaped particle refers to a particle having a maximum dimension and a secondary dimension orthogonal to the maximum dimension, wherein the ratio of maximum dimension to the secondary dimension is greater than about 1.2, preferably greater than about 1.5, more preferably greater than about 2.

An individual perfume-containing particle may have a volume from about 0.003 cm³ to about 0.15 cm³, preferably from about 0.005 cm³ to about 0.12 cm³.

In a preferred but not necessary embodiment of the present invention, perfume-containing particles of the present invention have a density lower than water, so that they can float on water. For example, such perfume-containing particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

A plurality of perfume-containing particles of the present invention can have different shapes, sizes, mass, and/or density.

The perfume-containing particles made by the method of the present invention may comprise: a perfume ingredient; polyethylene glycol; water-soluble or water-dispersible second carrier particles characterized by a specific particle size distribution; and optionally one or more adjunct ingredients, as described in detail hereinafter.

### Perfume Ingredients

The perfume-containing particles of the present invention may comprise from about 0.1 wt % to about 20 wt %, preferably from about 0.5 wt % to about 15 wt %, more preferably from about 1 wt % to about 10 wt % of one or more perfume ingredients, such as free perfumes, pro-perfumes, encapsulated perfumes (including perfume microcapsules), and the like.

In one embodiment, the perfume-containing particles comprise free perfumes and are substantially or essentially free of encapsulated perfumes. In such an embodiment, each perfume-containing particle may comprise no more than about 25%, preferably no more than about 20% (e.g., from about 0.1% to about 20%), more preferably from about 0.5% to about 15%, most preferably from about 1% to about 10%; alternatively, from about 9% to about 20%; alternatively, from about 10% to about 18%; alternatively, from about 11% to about 13%, alternatively, combinations thereof, of free perfumes by weight of such particle.

In another embodiment, the perfume-containing particles each comprise encapsulated perfumes (i.e., perfumes carried by a carrier material such as starch, cyclodextrin, silica, zeolites or clay or in form of perfume microcapsules), but are substantially or essentially free of free perfumes. Preferably, the perfume-containing particles comprise perfume oil encapsulated in perfume microcapsules (PMCs), which are preferably friable (verses, for example, moisture activated PMCs) but can also be moisture activated. For purposes of the present invention, the term “perfume microcapsules” or “PMC” describes both perfume microcapsules and perfume nanocapsules. In such an embodiment, each perfume-containing particle may each comprise from about 0.1% to 20%, preferably from about 0.5% to about 10%, more preferably from about 1% to about 5%, alternatively from about 4% to about 7%, alternatively from about 5% to about 7%, alternatively combinations thereof, of perfume microcapsules (preferably friable perfume microcapsules) by weight of the particles.

In yet another embodiment, each of the perfume-containing particles comprises both free perfumes and encapsulated perfumes (preferably in form of perfume microcapsules, and more preferably in form of friable perfume microcapsules), e.g., at a weight ratio ranging from about 1:5 to about 5:1, alternatively from about 1:4 to about 4:1, further alternatively from about 1:3 to about 3:1. In another embodiment, the perfume-containing particles may comprise from about 1% to about 10%, alternatively from about 2% to about 12%, alternatively from about 2% to about 8%, alternatively from about 3% to about 8%, alternatively from about 4% to about 7%, alternatively from about 5% to about 7%, alternatively combinations thereof, of PMCs by weight of the particles. In this embodiment, the perfume encapsulated by the PMC may comprise from about 0.6% to about 4% of perfume by weight of the particles.

In one embodiment, the PMCs comprise melamine/formaldehyde shells, which are commercially available from Appleton, Quest International, International Flavor & Fragrances, or other suitable sources. In a preferred embodiment, the shells of the PMCs are coated with polymer to enhance the ability of the PMCs to adhere to fabric.

In yet still another embodiment, the perfume-containing particles may comprise a formaldehyde scavenger. In yet still another embodiment, the scent of the perfume-containing particles is coordinated with scent(s) of other fabric care products (e.g., laundry detergent, fabric softener). This way, consumers who like APRIL FRESH scent, may use a packaged composition containing a plurality of perfume-containing particles having an APRIL FRESH scent, thereby coordinating the scent experience of washing their laundry with their scent experience from using APRIL FRESH. The perfume-containing particles of the present invention may be sold as a product array (with laundry detergent and/or fabric softener) having coordinated scents.

### First Carrier

The perfume-containing particles of the present invention comprise a first carrier. The first carrier in the perfume-containing particles may comprise water-soluble and hot-meltable material, preferably having melting point from 35° C. to 70° C. The first carrier can be materials selected from polyethylene glycol, polypropethylene glycol, ethylene oxide/propylene oxide block copolymers, nonionic surfactant, and combinations thereof. For example, the first carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

Preferably, each of the perfume-containing particles comprises from about 5 wt % to about 90 wt %, preferably from about 10 wt % to about 70 wt %, more preferably from about 20 wt % to about 60 wt % of PEG, and more preferably such PEG is characterized by a weight average molecular weight (Mw) ranging from about 2,000 to about 30,000 Daltons, preferably from about 3,000 to about 20,000 Daltons, more preferably from about 4,000 to about 15,000 Daltons. Suitable PEGs include homopolymers commercially available from BASF under the tradenames of Pluriol® E 8000.

A particularly preferred PEG within the meaning of the present invention is an ethylene oxide-propylene oxide-ethylene oxide (EOₓ₁PO_{y}EOₓ₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOₓ₁PO_{y}EOₓ₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOₓ₁PO_{y}EOₓ₂) triblock copolymer improve cleaning.

Suitable ethylene oxide—propylene oxide—ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

### Second Carrier

In addition to the above-described perfume ingredients and PEG, the perfume-containing particles of the present invention further comprise a second carrier in a particulate form.

The second carrier can be or comprise a water-soluble material selected from the group consisting of water-soluble inorganic alkali metal salt, water-soluble alkaline earth metal salt, water-soluble organic alkali metal salt, water-soluble organic alkaline earth metal salt, water soluble carbohydrate, water-soluble silicate, water soluble urea, and any combination thereof.

Alkali metal salts can be, for example, selected from the group consisting of salts of lithium, salts of sodium, and salts of potassium, and any combination thereof. Useful alkali metal salts can be, for example, selected from the group consisting of alkali metal fluorides, alkali metal chlorides, alkali metal bromides, alkali metal iodides, alkali metal sulfates, alkali metal bisulfates, alkali metal phosphates, alkali metal monohydrogen phosphates, alkali metal dihydrogen phosphates, alkali metal carbonates, alkali metal monohydrogen carbonates, alkali metal acetates, alkali metal citrates, alkali metal lactates, alkali metal pyruvates, alkali metal silicates, alkali metal ascorbates, and combinations thereof. Preferred alkali metal salts can be selected from the group consisting of, sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium acetate, sodium citrate, sodium lactate, sodium tartrate, sodium silicate, sodium ascorbate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium acetate, potassium citrate, potassium lactate, potassium tartrate, potassium silicate, potassium, ascorbate, and combinations thereof.

Alkaline earth metal salts can be selected from the group consisting of alkaline earth metal fluorides, alkaline earth metal chlorides, alkaline earth metal bromides, alkaline earth metal iodides, alkaline earth metal sulfates, alkaline earth metal bisulfates, alkaline earth metal phosphates, alkaline earth metal monohydrogen phosphates, alkaline earth metal dihydrogen phosphates, alkaline earth metal carbonates, alkaline earth metal monohydrogen carbonates, alkaline earth metal acetates, alkaline earth metal citrates, alkaline earth metal lactates, alkaline earth metal pyruvates, alkaline earth metal silicates, alkaline earth metal ascorbates, and combinations thereof. Preferred alkaline earth metal salts can be selected from the group consisting of salts of magnesium, salts of calcium, and the like, and combinations thereof, including, for example, magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium acetate, magnesium citrate, magnesium lactate, magnesium tartrate, magnesium silicate, magnesium ascorbate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium acetate, calcium citrate, calcium lactate, calcium tartrate, calcium silicate, calcium ascorbate, and combinations thereof.

The second carrier can also be water-dispersible material selected from the group consisting of zeolite, silica, clay, and combinations thereof.

Particularly preferred second carrier for the practice of the present invention include, but are not limited to: sodium chloride, sodium sulfate, sodium carbonate, sodium bicarbonate, sodium citrate, magnesium chloride, magnesium sulfate, potassium chloride, potassium sulfate, potassium carbonate, potassium bicarbonate, calcium bicarbonate, zeolite, silica, clay, and combinations thereof.

Preferably, from 80 wt % to 100 wt % of said second carrier present in the perfume-containing particles are characterized by a particle size ranging from 10 microns to 125 microns, preferably from 10 microns to 105 microns, more preferably from 10 microns to 90 microns. Preferably, the second carrier may be present in each perfume-containing particle in an amount ranging from about 1% to about 90%, preferably from about 5% to about 50%, more preferably from about 8% to about 40%, by total weight of each perfume-containing particle.

The water-soluble or water-dispersible second carrier is present in the perfume-containing particles in a particulate form, i.e., as discrete particles having a specific particle size distribution. Such specific particle size distribution is particularly effective for reducing compositional variations of the perfume-containing particles from batch to batch. Without being bound by any theory, it is believed that because the second carrier particles, if used separately, may not dissolve in the molten polymer blend during the perfume particle making process, such particles may sediment to the bottom of the mixing tank, thereby causing compositional variations in the perfume particles so formed. One way to mitigate this problem is to provide constant and increased agitation in the mixing tank to reduce the sedimentation, but this approach results in significant increase in capital investment, operational cost, and processing complexity. Inventors of the present invention discovered that by making intermediate particle that comprises the second carrier particle with specific particle size (e.g., no more than 150 microns) and a binder, compositional variations in the perfume particles so form can be significantly reduced, without the need for constant and increased agitation in the mixing tank. Therefore, the sedimentation problem can be effectively resolved or mitigated by the present invention little or no increase in capital investment, operational cost, and/or processing complexity.

Specifically, from about 80 wt % to 100 wt %, preferably from about 85 wt % to 100 wt %, more preferably from about 90 wt % to 100 wt %, still more preferably from about 95 wt % to 100 wt %, still more preferably from about 98 wt % to 100 wt %, and most preferably from about 99 wt % to 100 wt % of the second carrier in the perfume-containing particles have a particle size of no more than 150 microns. Preferably, from about 80 wt % to 100 wt % of the second carrier discrete particle in the perfume-containing particles have a particle size of from about 5 microns to about 150 microns, preferably from about 10 microns to about 125 microns, more preferably from about 10 microns to about 105 microns, most preferably from about 10 microns to about 90 microns. Particle sizes of the second carrier in the perfume-containing particles can be readily determined by the Micro-CT test described hereinafter in Test Method 1.

Preferably, each of the perfume-containing particles comprises from about 5 wt % to about 90 wt %, preferably from about 10 wt % to about 70 wt %, more preferably from about 20 wt % to about 60 wt % of water-soluble or water-dispersible filler particles.

Preferably, the binder in the intermediate particle comprises material that can be compatible with the first carrier. Particularly, the binder can comprise the same or different materials as the first carrier. For example, the binder used in the intermediate particle may comprise materials selected from polyethylene glycol, ethylene oxide/propylene oxide block copolymers, polyvinyl alcohol, polyvinyl acetate, and derivatives thereof; gelatin, albumin, casein, dextrose, fructose, galactose, glucose, isoglucose, sucrose; polysaccharides, cellulose, starch, or derivatives thereof; nonionic surfactant, anionic surfactant, cationic surfactant, and combinations thereof.

In some preferred examples, the weight ratio of the second carrier to the binder in the intermediate particle is about 50-99: 1-50. For example, the weight ratio of the second carrier to the binder in the intermediate particle can be 50:50, or 55:45, or 60:40, or 65:35, or 70:30, or 75:25, or 80:20, or 85:15, or 90:10, or 95:5, and any combination between the above-mentioned ranges.

### Optional/Adjunct Ingredients

The perfume-containing particles of the present invention may optionally comprise one or more optional/adjunct ingredients, including colorants, solvents, softening actives, germ killing materials, anti-mite materials, dye transfer inhibitors, silicone, polymer, and combinations thereof, in an amount ranging from about 0.01 wt % to about 30 wt %, preferably from about 0.02 wt % to about 25 wt %, more preferably from about 0.1 wt % to about 15 wt %. Such option/adjunct ingredients can be added in the step of mixing with first carrier, intermediate particles and perfumes, or can be added into the intermediate particles with the second carrier and binder as long as the materials are compatible. Alternatively, some of optional/adjunct ingredients can be added into the intermediate particle while some of the optional/adjunct ingredients can be added directly in the mixing step.

The colorants may impart to the perfume-containing particles a color selected from the group consisting of blue, green, yellow, orange, pink, red, purple, grey, and the like. The colorants may be selected from the group consisting of dyes, pigments, and combinations thereof. Preferably, the colorants include at least one dye selected from those typically used in laundry detergent or fabric softeners. Examples of suitable dyes include, but are not limited to, LIQUITINT BLUE BL, LIQUITINT PINK AM, AQUA AS CYAN 15, and VIOLET FL, available from Milliken Chemical. If a dye is employed, the perfume-containing particles may comprise less than about 0.1%, alternatively about 0.001% to about 0.1%, alternatively about 0.01% to about 0.02%, alternatively combinations thereof of such dye by weight of the particles.

The perfume-containing particles of the present invention may be substantially free of laundry active and/or fabric softener actives. To reduce costs and avoid formulation capability issues, one aspect of the invention may include perfume-containing particles that are essentially free or completely free of laundry actives and/or fabric softener actives. In one embodiment, each of the perfume-containing particles comprises less than about 3%, alternatively less than about 2%, alternatively less than about 1%, alternatively less than about 0.1% by weight of the perfume-containing particles, of laundry actives and/or fabric softener actives (or combinations thereof). Laundry actives may include detergent surfactants, detergent builders, bleaching agents, enzymes, mixtures thereof, and the like. It is particularly preferred that the perfume particles of the present invention are substantially free of or essentially free of surfactants, because the presence of such surfactants may speed up dissolution of the perfume particles in water, which is undesirable in the context of the present invention. It is appreciated that a non-detersive level of surfactant may be used to help solubilize perfume contained in the composition. More preferably, the perfume particles of the present invention are substantially free of or essentially free of any detersive actives.

Depending on the application, the perfume-containing particles of the present invention may comprise a solvent selected from the group consisting of glycerin, polypropylene glycol, isopropyl myristate, dipropylene glycol, 1,2-propanediol, and PEG having a weight average molecular weight less than 2,000, and mixtures thereof.

The perfume-containing particles can further comprise an antioxidant. The antioxidant can help to promote stability of the color and or odor of the particles over time between production and use. The perfume-containing particles can comprise between about 0.001% to about 2%, preferably between 0.01% to about 1%, more preferably between about 0.05% to about 0.5% by weight of such antioxidant. The antioxidant can be butylated hydroxytoluene.

### Packaged Composition

A unit dose of the perfume-containing particles made by the method of the present invention, or a plurality of such unit doses may be contained in a package, to form a packaged composition. The package may be a bottle, bag, or other container. In one embodiment, the package is a bottle, preferably a PET bottle comprising a translucent portion to showcase the perfume-containing particles to a viewing consumer. In one embodiment, the package comprises a single unit dose (e.g., trial size sachet), or multiple unit doses (e.g., from about 15 unit doses to about 30 unit doses).

### Dosing

A plurality of perfume-containing particles may collectively comprise a unit dose for dosing to a laundry washing machine or laundry was basin. A single unit dose of the pastilles may comprise from about 13 g to about 27 g, alternatively from about 14 g to about 20 g, alternatively from about 15 g to about 19 g, alternatively from about 16 g to about 18 g, alternatively combinations thereof.

The aforementioned package may comprise a dosing means for dispensing the perfume-containing particles from a package to a laundry washing machine (or laundry wash basin in hand washing applications). The user may use the dosing means to meter the recommended unit dose amount or simply use the dosing means to meter the perfume-containing particles according to the user's own scent preference. Examples of a dosing means may be a dispensing cap, dome, or the like, that is functionally attached to the package. The dosing means can be releasably detachable from the package and re-attachable to the package, such as for example, a cup mountable on the package. The dosing means may be tethered (e.g., by hinge or string) to the rest of the package (or alternatively un-tethered). The dosing means may have one or more demarcations (e.g., fill-line) to indicate a recommend unit dose amount. The packaging may include instructions instructing the user to open the removable opening of the package, and dispense (e.g., pour) the perfume-containing particles contained in the package into the dosing means. Thereafter, the user may be instructed to dose the perfume-containing particles in the dosing means to a laundry washing machine or laundry wash basin. The perfume-containing particles of the present invention may be used to add freshness to laundry. The package including the dosing means may be made of plastic.

In one embodiment, the perfume-containing particles of the present invention can be administered to a laundry machine as used during the “wash cycle” of the washing machine (but a “rinse cycle” may also be used). In another embodiment, the perfume-containing particles of the present invention are administered in a laundry wash basin—during washing and/or rinsing laundry. In a laundry hand rinsing application, the perfume-containing particles may further comprise an “antifoam agent” such as those available from Wacker.

### Test Methods

### Test Method 1: Micro-CT Test for Measuring Particle Sizes of Second Carrier in Perfume-Containing Particles

X-ray Micro-CT is used to acquire and analyze images of second carrier (water-soluble or water-dispersible particles) in a sample for particle size determination according to the present invention.

A 10 mm punch (in diameter) is used to physically extract a representative region of a sample. The punched sample (around 10 mm in diameter) is then mounted on a sample holder. The sample holder is then placed in an X-ray scanner such as GE Phoenix vl tomel x m. (GE Sensing & Inspection Technologies GmbH Niels-Bohr-Str.7 31515 Wunstorf, Germany). The scanning parameters used include: micro-tube; voltage:180 kV; current: 120 μA; tube mode: 1; timing: 1000 ms; averaging: 2; skip frames: 1; number of images: 1500. The resulting data set is 2014×2014×2014 voxels with attenuation values represented as 16 bit integers. Each voxel has a diameter of 7 microns.

To measure particle size distribution in the sample, the following steps can be performed:
1. An automated thresholding algorithm (Otsu's method, which is a well-known thresholding method implemented in Matlab; see “A Threshold Selection Method from Gray-Level Histograms”, Nobuyuki Otsu, 2EEE Transactions On Systems Man, and Cybernetics, VOL. SMC-9, NO. 1, January 1979) is applied to each of the datasets resulting in a labelled image representing the particles (gray level 2), matrix (gray level 1), and void (gray level 0).
2. The labelled image datasets are imported into Fiji (v1.51u), followed by a further thresholding step where the particles are set to gray level 255 and the rest set to gray level 0.
3. Next, a Fiji embedded plugin called “3D watershed split” is used to separate the particles next to each other and give each particle a unique ID in three dimensional space (see J. Ollion, J. Cochennec, F. Loll, C. Escudé, T. Boudier. (2013) TANGO: “A Generic Tool for High-throughput 3D Image Analysis for Studying Nuclear Organization”, Bioinformatics 2013 Jul. 15; 29(14): 1840-1).
4. The calculated “3D watershed split” datasets are imported into “3D manager”, a plugin in Fiji to measure the minimum center to surface distance (DCmin). The center to surface distance (DCmin) less than 1 voxel was filtered out as noise. The minimum diameter (Dmin) is calculated by Dmin=DCmin*2 and is recorded as the size of the respective particles.

### EXAMPLES

### Example 1: Inventive Perfume-Containing Beads

First, intermediate particles are prepared by extrusion or hot-melt granulation of PEG9000, sodium sulfate particle having fine particle size distribution (<120 um), and optionally other ingredients. The intermediate particles A and B have a noodle-like shape with a maximum dimension of 6 mm and 5 mm respectively.

| | Intermediate particle A | Intermediate particle B |
|---|---|---|
| PEG9000 | 9.5% | 10% |
| Fine Sodium Sulfate * | 90% | 90% |
| Anhydrous citric acid | 0.5% | — |
| Maximum dimension of | 10 mm | 8 mm |
| intermediate particle | | |

* particle size < 120 um

Secondly, a PEG9000 raw material is heated in an oven at 75° C. overnight to form a molten PEG slurry.

Suitable amounts of the molten PEG slurry, the intermediate particles, perfume microcapsules, and free perfumes are measured and mixed to form respective perfume-containing compositions, with specific compositional breakdowns as indicated by the Table 1 below. The mixture is hand-mixed for about 10 minutes to form a viscous and homogenous slurry (this can also be done with a motor-driven agitator), while the beaker is placed on a heater to maintain the mixture at a temperature of about 75° C.

The viscous slurry is then poured into molds containing bead-shape cavities at about 30 seconds after the mixing step is completed. The viscous slurry cools down to ambient temperature in molds, thereby forming solidified bead-shaped perfume-containing particles.

TABLE 1

Example

| Wt (%) | 1 | 2 | 3 | 4 |
|---|---|---|---|---|
| PEG9000 | 74 | 83 | 78 | 64 |
| Intermediate particle A | 20 | 10 | — | — |
| Intermediate particle B | — | — | 15 | 30 |
| Perfume microcapsules | 3 | 3.5 | 3.5 | — |
| Free perfumes | 3 | 3.5 | 3.5 | 6 |
| Total: | 100 | 100 | 100 | 100 |

Particle sizes of the second carrier (sodium sulfate in the Examples in Table 1) in the perfume-containing particles can be readily determined by the Micro-CT test described in Test Method 1. It is characterized that 80 wt % to 100 wt % of the second carrier are characterized by a particle size ranging from 5 microns to 150 microns.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of making perfume-containing particles, wherein the perfume-containing particles comprise: a perfume ingredient; a first carrier, and a second carrier, wherein the first carrier comprises water-soluble and hot-meltable material, and the second carrier comprises water-soluble or water-dispersible particle, wherein from 80 wt % to 100 wt % of the second carrier are characterized by a particle size ranging from 5 microns to 150 microns, wherein each of said perfume-containing particles has a mass of from 0.1 mg to 5 g and a maximum dimension of from 3 mm to 10 mm, said method comprising steps of:
a) providing an intermediate particle characterized by a maximum dimension ranging from 0.5 mm to 10 mm, wherein the intermediate particle comprises at least the second carrier, and a binder,
b) mixing the intermediate particle, the perfume ingredient, the first carrier in a molten state, and optionally one or more other ingredients, to form a slurry, and
c) forming the perfume-containing particles from the slurry.

2. The method according to claim 1, wherein the intermediate particle is provided by granulation, selected from the group consisting of high-shear wet granulation, low-shear wet granulation, fluid bed wet granulation, dry granulation, spray drying granulation, rotor granulation, extrusion, and hot-melt granulation.

3. The method according to claim 1, wherein the first carrier comprises water-soluble and hot-meltable material having melting point from 35° C. to 70° C., which is selected from polyethylene glycol, polypropethylene glycol, ethylene oxide/propylene oxide block copolymers, nonionic surfactant, and combinations thereof.

4. The method according to claim 1, wherein from 80 wt % to 100 wt % of said second carrier present in the perfume-containing particles are characterized by a particle size ranging from 10 microns to 125 microns.

5. The method according to claim 1, wherein the second carrier comprises a material selected from the group consisting of sodium chloride, sodium sulfate, sodium carbonate, sodium bicarbonate, sodium citrate, magnesium chloride, magnesium sulfate, potassium chloride, potassium sulfate, potassium carbonate, potassium bicarbonate, calcium bicarbonate, zeolite, silica, clay, and combinations thereof.

6. The method according to claim 1, wherein the binder in the intermediate particle comprises materials selected from polyethylene glycol, ethylene oxide/propylene oxide block copolymers, polyvinyl alcohol, polyvinyl acetate, and derivatives thereof, gelatin, albumin, casein, dextrose, fructose, galactose, glucose, isoglucose, sucrose, polysaccharides, cellulose, starch, or derivatives thereof, nonionic surfactant, anionic surfactant, cationic surfactant, and combinations thereof.

7. The method according to claim 1, wherein the weight ratio of the second carrier to the binder in the intermediate particle is 50-99: 1-50.

8. The method according to claim 1, wherein the second carrier in each of said perfume-containing particles is present in an amount ranging from 1% to 90%, by total weight of each perfume-containing particle.

9. The method according to claim 1, wherein each of said perfume-containing particles comprises one or more free perfumes, which are present in an amount ranging from 0.1% to 20%, by total weight of each perfume-containing particle.

10. The method according to claim 1, wherein each of said perfume-containing particles comprises an encapsulated perfume, which is present in friable perfume microcapsules, and wherein the friable perfume microcapsules are present in an amount ranging from 0.1% to 20%, by total weight of each perfume-containing particle.

11. The method according to claim 1, wherein the first carrier is present in each of said perfume-containing particle in an amount ranging from 5% to 90%, by total weight of each perfume-containing particles.

12. The method according to claim 1, wherein each of the perfume-containing particles comprises one or more other ingredients selected from the group consisting of colorants, solvents, softening actives, and combinations thereof, and wherein said one or more ingredients are present in an amount ranging from 0.01% to 10%, by total weight of each perfume-containing particle.

13. The method according to claim 1, wherein each of said perfume-containing particles has a hemispherical shape or a compressed hemispherical shape.

14. The method according to claim 1, wherein the intermediate particle is characterized by a maximum dimension ranging from 0.6 mm to 9 mm.

15. The method according to claim 1, wherein the first carrier comprises water-soluble and hot-meltable material selected from polyethylene glycol having a weight average molecular weight (Mw) from 2,000 to 30,000 Daltons.
